(19) United States
(12) Patent Application Publication
(10) Pub. No.: US 2007/0237560 A1
(43) Pub. Date: Oct. 11, 2007

(54) Stand-alone hand-held printer and systems with display for print quality

(76) Inventors: Thomas Daniel Brown, Frankfort, KY (US); Gary Lee Noe, Lexington, KY (US); William Henry Reed, Lexington, KY (US); Maini Helena Williams, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/391,155

(22) Filed: Mar. 28, 2006

(51) Int. Cl. B41J 3/36

(52) U.S. Cl. 400/88

(57) ABSTRACT

Stand-alone hand-held printers comprising a housing, a printhead, one or more sensors, and a display. The one or more sensors are adapted to detect relative position of the print head during an ongoing print job. The hand-held printer is configured to show one or more print quality features of the ongoing print job on the display. Systems including the hand-held printer.

### TECHNICAL FIELD

The present invention relates to apparatuses and methods for operator feedback on print quality for a hand-held printer, and more particularly, a display configured to alert the user of unprinted areas or voids in the printout and guide the user to make corrections.

### BACKGROUND OF THE INVENTION

Inkjet printing is a conventional technique by which printing is accomplished without contact between the printhead and the substrate or medium, on which the desired print characters are deposited. Such printing is accomplished by ejecting ink from an inkjet printhead of the printing apparatus via numerous methods which employ, for example, pressurized nozzles, electrostatic fields, piezo-electric elements and/or heaters for vapor phase droplet formation.

Recently, there has been a desire for a hand-held printer which utilizes the same inkjet printing technology. Most printers operate by moving paper under the printing element. This is true for “page printers” which have an active print zone extending across the full width of the paper and true for “serial printers” that must also move the print element across the paper width in addition to moving the length of the paper by the print element. This relative movement of paper and print element is the traditional configuration for digital printers. An alternative approach is to fix the position of the paper while the print element is moved over the paper during printing. An example of this alternative approach is a flatbed plotter where the movement of the print element is controlled by fixed mechanical references along and outside the paper edges. It is desired to have a printer that is moved manually over the surface of the paper without mechanical linkage and without mechanical control from a fixed reference point. This type of printer is sometimes called a “hand printer” or “random motion printer.” One advantage of this type of printer is the potential for compact size which makes it attractive for mobile printing applications.

Because movement of a hand-held printer over the page by an operator is not precise, errors in the printout may result when sections of the page are not traversed and no opportunity is given to print in those sections. This can result in voids or unprinted areas, in the printed document. While prior references have developed methods to avoid printing twice in the same location, none of the prior art methods provide for assuring that all sections of the page are covered and printed. This problem of unprinted areas or voids in the printed output can be aggravated by the reality that once the hand-held printer is removed from paper, accurate repositioning to add missing print is difficult. As such, there is a need for new methods and apparatus to inform the operator that areas of print have been missed before the hand-held printer is removed from the paper. Accordingly, improved apparatus and methods are desired.

### SUMMARY OF THE INVENTION

The present invention relates to new and improved methods and apparatus for alerting the operator of a hand-held printer or hand printer that sections of the latent image intended to be printed have been missed and for providing the instructions to return the printhead back to complete the print. One aspect of the present invention is a stand-alone hand-held printer. The stand-alone hand-held printer comprises a housing; a printhead; and one or more sensors adapted to detect a relative position of the printhead during an ongoing print job, and a display configured to show one or more print quality features in the ongoing print job.

Another aspect of the present invention is a hand-held printer system. The hand-held printer system comprises a stand-alone hand-held printer having a housing; one or more sensors; and a printhead. The system further comprises a host device and a display. The display is in communication with the host device and further wherein the host device is configured to show on the display voids in an ongoing print job.

Yet another aspect of the present invention is a stand-alone hand-held printer comprising a housing; a printhead, one or more sensors adapted to detect the relative position of the printhead; and a user's signal configured to inform the user of voids in the ongoing print job.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic illustration of an exemplary hand-held printer according to the first embodiment of the present invention; and

FIG. 2 is a schematic illustration of an exemplary display according to an embodiment of the present invention.

The embodiments set forth in the drawings are illustrative in nature and not intended to be limiting of the invention as defined by the claims. Moreover, individual features of the drawings and the invention will be more fully apparent and understood in view of the detailed description.

### DETAILED DESCRIPTION

Reference will now be made in detail to various embodiments which are illustrated in the accompanying drawings, wherein like numerals indicate similar elements throughout the views.

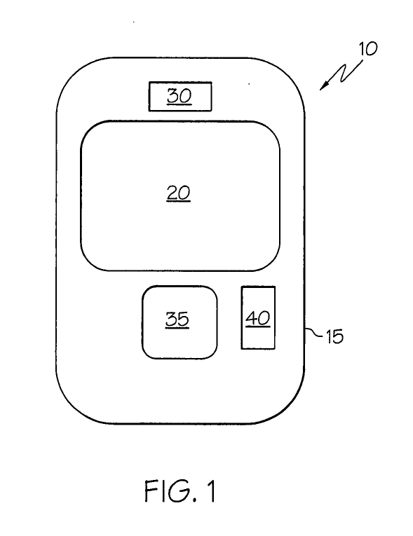

One embodiment of the present invention, a hand-held printer 10, is illustrated in FIG. 1. The hand-held printer 10 includes a housing 15, a printhead 30, and a display 20. The display 20 is configured to show one or more print quality features in the ongoing print job. The hand-held printer 10 further comprises one or more sensors 35 adapted to detect a relative position of the printhead during an ongoing print job. In one exemplary embodiment, the printhead 30 comprises an inkjet printhead.

In another embodiment, the hand-held printer 10 further comprises a controller 40, wherein the controller is configured to calculate voids in an ongoing print job. For example, since the printer is a hand-held printer, the user may not move the printer in perfect alignment with the print media. By utilizing one or more sensors on the printer, the controller can calculate any area of the item to be printed that was missed due to the motion of the hand-held printer. These missed areas may be referred to as unprinted areas or voids in the printer job. In an alternative embodiment, the hand-held printer 10 is in communication with an external controller (such as a computer, docking station or mobile information device). The external controller monitors the ongoing print job and is configured to detect any voids.

In one embodiment, the display 20 is configured to show a portion of the ongoing print job. For example, due to size limitations, the display 20 may only show a portion of the printed page or, alternatively, it may show the entire printed page. In another exemplary embodiment, the user can switch back and forth between a zoomed in portion of the printed page versus the entire printed page display.

In another embodiment, the hand printer 10 is in communication with a computer or mobile information device. The page to be printed and any void information can be displayed on a screen attached to or in communication with the computer or mobile information device.

As the user moves the hand printer over the page during printing, the image of the page displayed is refreshed so the operator can see what areas have been printed and what areas remain yet unprinted (i.e., voids). In one exemplary embodiment, the display can be integrated into the printer driver or print application or as a separate application running on the computer or mobile information device. In another exemplary embodiment, the page may be initially displayed in one color and areas changed to another (for example, less prominent color once printed, leaving the omitted areas in highlight). The remaining highlighted areas will attract the attention of the user and guide the user's hand to cover those void areas on the page. As noted above, not all of the latent page of the display needs to be highlighted. In one embodiment, only those areas containing information to be printed will be highlighted.

In another embodiment of the present invention, the hand-held printer is configured to provide print void feedback to the user via audio, visual and/or tactile signals. In one embodiment, a sound beacon or signal alerts the user that voids have been left in the print area. In another exemplary embodiment, the sound beacon is configured to guide the user back to the void area to make corrections. An audio frequency alert (such as a continuous tone or beat) can be sounded anytime voids have been created in a hand printed page. As the operator moves the printhead further away from the void, the alert changes in frequency or beat rate. When the user elects to move back on the page to address the voids, he can be guided by the change in the alert. For example, the alert may be similar to what happens when sweeping with a metal detector or Geiger counter. Once the void has been filled in, the audio alert will be silenced. When the page is printed and no alerts are active, the user will then know that he can confidently remove the hand printer from the printed page without leaving any void areas in the printed page. In another exemplary embodiment, an auditory confirmation signal is transmitted when the print job has been completed.

In yet another exemplary embodiment, the audio alert is replaced with a visual signal. For example, a light on the hand printer may blink or change intensity to indicate that voids have been created in the print and to guide the user back to make corrections. In another embodiment, the audio signal may be replaced with a tactile feedback such as vibrations configured to change in intensity or periodicity.

In one exemplary embodiment, the user would be able to adjust the sensitivity of a void detection. For example, the different settings for print quality might correspond to thresholds for allowable void size. In one exemplary embodiment, if the print quality of 12 pt text is acceptable with 10% of character height voided, then the threshold void side would be (⅙ inch) (10%) equals ( 1/60 inch). The values selected for thresholds will depend on the resolution of the print element and user input. In one exemplary embodiment, the signal may be turned off during the initial draft passes then activated during a cleanup phase at the end of the printing process. For example, if void alerts are normally inactive, a signal may be given when a page has been successfully completed within the acceptable limits. If the operative completes a printed page before the success signal, he can then choose whether to activate void detection or accept the current printed result.

As noted above, in one exemplary embodiment, the hand-held printer is in communication with a mobile information device. Exemplary mobile information devices comprise cell phones, personal digital assistance (PDAs), pagers, MP3 or music/video players, watches, and the like.

The stand-alone printer comprises one or more sensors adapted to detect the position of the print head during an ongoing print job. This information is utilized to calculate the print quality feedback to the user regarding voids. As will be appreciated by one skilled in the art, various methods for calculating the relative position of the print head can be utilized in the present invention. For example, optical sensors, rotary encoders and other technologies such as those used in the hand-held mouse may be utilized.

In one exemplary embodiment, the hand-held printer is in communication with a host device and/or mobile information device. For example, the hand-held printer may be connected to the host device via a communication link. This communication link may be wired or wireless, such as Bluetooth, IR or other known communication technology. In one exemplary embodiment, the processing and calculation of the print voids takes place in at least some part on the hand-held printer. In another embodiment, such processing takes place on the host device or mobile information device.

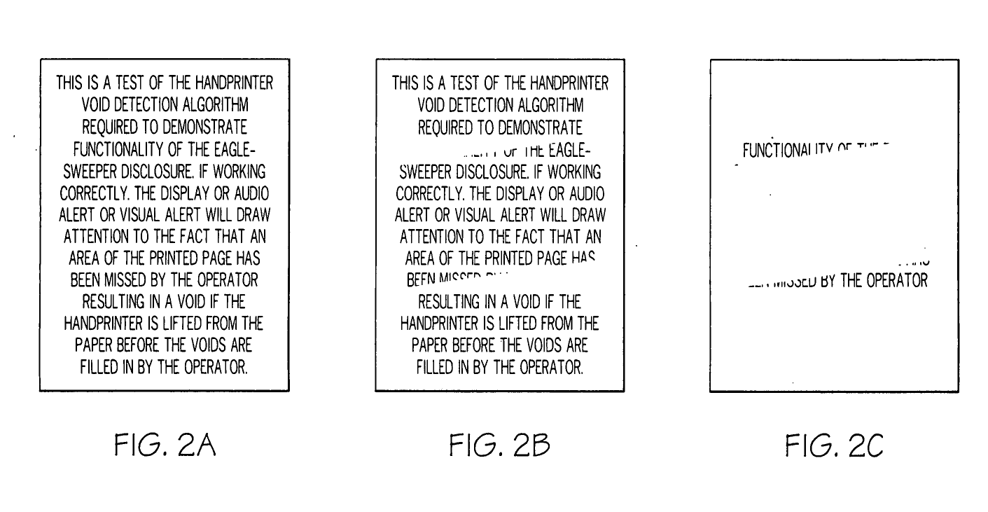

FIG. 2A illustrates an exemplary illustration of the latent image to be printed. This latent image can be displayed on the display device. FIG. 2B is an exemplary illustration of a printed page with voids, and FIG. 2C is an exemplary illustration of the corresponding display highlighting the print void areas.

In one exemplary embodiment, the display may also show a virtual position of the print head on the printed page displayed. In this embodiment, the user can move the virtual print head over the void area to aid the user to find the correct location to fill in the void.

As noted above, the application used to calculate print voids can operate on an external host device. The external host device may comprise a computer, a docking station or other peripheral device with sufficient computing power to format the print job and determine print voids. In an alternative embodiment, the application used to calculate print voids operates on the hand-held printer.

The foregoing description of various embodiments and principles of the invention has been presented for the purposes of illustration and description. It is not intended to be exhaustive or to limit the invention to the precise forms disclosed. Many alternatives, modifications and variations will be apparent to those skilled in the art. For example, some principles of the invention may be used in different inkjet printer configurations, as well as in hand-held scanning operations. Moreover, although multiple inventive concepts have been presented, such aspects need not be utilized in combination, and various combinations of inventive aspects are possible in light of the various embodiments provided above. Accordingly, the above description is intended to embrace all alternatives, modifications, combinations and variations that have been discussed or suggested herein, as well as all others that fall within the principles, spirit and broad scope of the invention as defined by the claims.

We claim:

1. A stand-alone hand-held printer comprising:
a housing;
a print head;
one or more sensors adapted to detect relative position of the print head during an ongoing print job;
and a display configured to show one or more print quality features in the ongoing print job.

2. The stand-alone hand-held printer of claim 1, wherein the print head comprises an inkjet print head.

3. The stand-alone hand-held printer of claim 1, further comprising a controller configured to calculate voids in an ongoing print job.

4. The stand-alone hand-held printer of claim 1, wherein the one or more print quality features comprises void detection.

5. The stand-alone hand-held printer of claim 1, wherein the display is configured to display a portion of the ongoing print job.

6. The stand-alone hand-held printer of claim 1, further comprising a signal, wherein the signal is configure to alert a user of a print quality issue in the ongoing print job.

7. The stand-alone hand-held printer of claim 6, wherein the signal comprises one or more signals selected from the group consisting of: audio signals, visual signals, tactile signals and combinations of such.

8. A hand-held printer system, comprising:
a stand-alone hand-held printer having a housing, one or more sensors and a printhead:
a host device; and
a display, wherein the display is in communication with the host device, and further wherein the host device is configured to show on the display voids in an ongoing print job.

9. The system of claim 8, wherein the host device is configured to send instructions to the display such that areas that have been printed and areas that have not been printed during the ongoing print job are shown on the display.

10. The system of claim 8, wherein the host device comprises a mobile information device and the display is integral to the mobile information device.

11. A stand-alone hand-held printer comprising:
a housing;
a print head; and
a user signal configured to inform a user of voids in an ongoing print job.

12. The printer of claim 11, wherein the signal comprises an audio signal.

13. The printer of claim 11, wherein the signal comprises a visual signal.

14. The printer of claim 12, wherein the audio signal is configured to emit a frequency tone, wherein the frequency tone corresponds to a location of one or more voids in the ongoing print job.

15. The printer of claim 13, wherein the visual signal comprises a light on the printer.

16. The printer of claim 15, wherein the light is configured to change intensity and/or frequency to correspond to the location of the voids.

17. The printer of claim 11, wherein the signal comprises a tactile signal.

18. The printer of claim 17, wherein the tactile signal is configured to provide a vibration frequency in correspondence to a location of one or more voids.

19. The stand-alone hand-held printer of claim 3, further wherein the controller is configured with one or more predetermined print quality thresholds.
